(19) United States
(12) Patent Application Publication
(10) Pub. No.: US 2011/0202478 A1
(43) Pub. Date: Aug. 18, 2011

(54) Group-Based Art Project System and Methods

(76) Inventor: Jon Terry Cox, Riverton, WY (US)

(21) Appl. No.: 12/705,961

(22) Filed: Feb. 15, 2010

(51) Int. Cl. G06Q 90/00; G09B 11/10

(52) U.S. Cl. 705/500; 434/84

(57) ABSTRACT

A method for conducting a group-based activity includes providing a master visual art work suitable for reproduction. A copy of the master visual art work is made and divided into a plurality of divided pieces. Each of the divided pieces is paired with a corresponding blank piece having substantially the same shape as the corresponding divided piece. Each of the pairs is distributed to at least one participant of the group-based activity, and the participants are instructed to reproduce the divided piece on the blank piece using supplies distributed with each of the pairs. The reproduced pieces are collected and assembled to form a reproduction of the master visual art work.

### BACKGROUND OF THE INVENTION

1. Field of the Invention

The present invention relates generally to group-based activities and more particularly to group-based activities centered on visual works of art such as paintings, photographs, drawings, sculptures, statues, and the like.

2. Related Art

Paint-by-number kits include a board or canvas on which outlines indicate areas to paint. Each area has a number and the kits include corresponding numbered paint to use in the numbered area. Carefully painting all of the areas can produce work of art often suitable for framing.

Many paint-by-number kits focus on realist subject matter such as landscapes, seascapes, animals, clowns, or the like. However, some paint-by-number kits allow the paint-by-number artist to reproduce famous masterpiece artwork. In this way, the paint-by-number artist can produce relatively complex artwork even without formal artistic training, and thus gain insight and a deeper appreciation for the process of painting.

Unfortunately, paint-by-number kits have some limitations with respect to providing a hands-on participation in the creation of art. For example, generally, a paint-by-number kit is intended to be sold to and completed by a single painter. Hence, only this single painter will gain the experience of the art project but miss out on the benefits of a collaborative team approach to completing the project.

Additionally, revenue from an art project such as a paint-by-number kit is usually limited to sale of the kit and possibly sale of the completed paint-by-number artwork. Moreover, paint-by-number kits are usually limited to graphical two-dimensional works of art such as paintings.

### SUMMARY OF THE INVENTION

The inventor of the present invention has recognized that it would be advantageous to develop a step-by-step art project that is group-based in reproducing a complex work of art. Additionally, the inventor of the present invention has recognized that it would be advantageous to develop a group-based activity that reproduces a master work of art by having members of the group produce different portions of the work of art which can be combined or assembled to produce a replica of the master work of art so as to enhance the collaborative effort of reproducing the master work of art. Moreover, the inventor of the present invention has recognized that it would be advantageous to develop a step-by-step, group-based activity that reproduces a two-dimensional or three-dimensional work of art. Furthermore, the inventor of the present invention has recognized that it would be advantageous to provide a group-based step-by-step art project that provides for multiple opportunities to raise funds through participation in the art project.

The invention provides a system for conducting a group-based activity including a master visual art work suitable for reproduction. The system also includes a copy of the master visual art work that can be divided into a plurality of divided pieces. The system can also include a plurality of blank pieces. Each blank piece can correspond to a different one of the plurality of divided pieces. Additionally, the system can include supplies for altering each blank piece to reproduce the corresponding divided piece.

In accordance with another aspect of the present invention, the group based activity can be a fundraiser and the system can include offers for selling of the individual blank pieces with associated supplies, offers for selling the master visual art work, and offers for selling the reproduced assembly of the master visual art work. Additionally, the group-based activity can “pre-sell” images of future fundraising events as a result of the excitement just experienced in the present art project.

In accordance with other aspects of the invention, the group-based activity can be a team building activity and the system can include instructions and question for assisting participants of the group based activity in building team skills.

In accordance with another aspect of the invention, the master visual art work can include a two dimensional graphic work of art such as a painting, photograph, computer graphic, and the like.

In accordance with yet another aspect of the invention, the master visual art work can include a three dimensional work of art such as a sculpture, statue, model, and the like.

The present invention also provides a method for conducting a group-based activity including providing a master visual art work suitable for reproduction. A copy of the master visual art work can be made and the copy can be divided into a plurality of divided pieces. Each of the pieces can be paired with a corresponding blank piece having substantially the same shape as the corresponding divided piece. Each of the pairs can be distributed to at least one participant of the group-based activity, and the participants can be instructed to reproduce the divided piece on the blank piece using supplies distributed with each of the pairs. The reproduced pieces can be collected and assembled to form a reproduction of the master visual art work.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of an art project system in accordance with an embodiment of the present invention;

FIG. 2 is a schematic view of an art project system in accordance with another embodiment of the present invention; and

FIG. 3 is a flow chart of a method for conducting a group-based activity using the art project systems of FIGS. 2 and 3.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a system and method for conducting a group-based activity that produces a replica or reproduction of a master or original work of art by having members of the group produce different portions of the replica which can reproduce the master when combined or assembled. The system can include a master visual work of art, such as a painting or sculpture, and a scaled reproduction of the master. The reproduction can be divided into a plurality of pieces. Each of the divided pieces can be paired with a scaled blank piece that generally corresponds proportionally to the divided piece in shape. The system can also include supplies for altering the blank piece in order to recreate the divided piece with the blank piece. The supplies can be grouped together with the pairs of divided and blank pieces so as to form a plurality of kits that can be distributed to participants of the group activity.

In use each of the kits can be distributed to members of a group that is participating in the group-based activity. Each participant that has a kit then uses the supplies in the kit to transform each blank piece into a scaled replica of the divided piece. When complete each replica can be combined or assembled together in order to form a scaled reproduction of the master visual artwork.

In one embodiment, the group-based activity can be a fundraiser presenting multiple opportunities for generating revenue from sales of the plurality of kits, sale of the scaled replica formed from the replica pieces created by the participants, and sale of the master visual work of art.

In another embodiment, the group-based activity can be a team building activity that can foster teamwork, communication skills, collaboration, and the like, amongst participants by engaging the participants in introspective question and answer sessions upon successful or attempted assembly of the scaled reproduction.

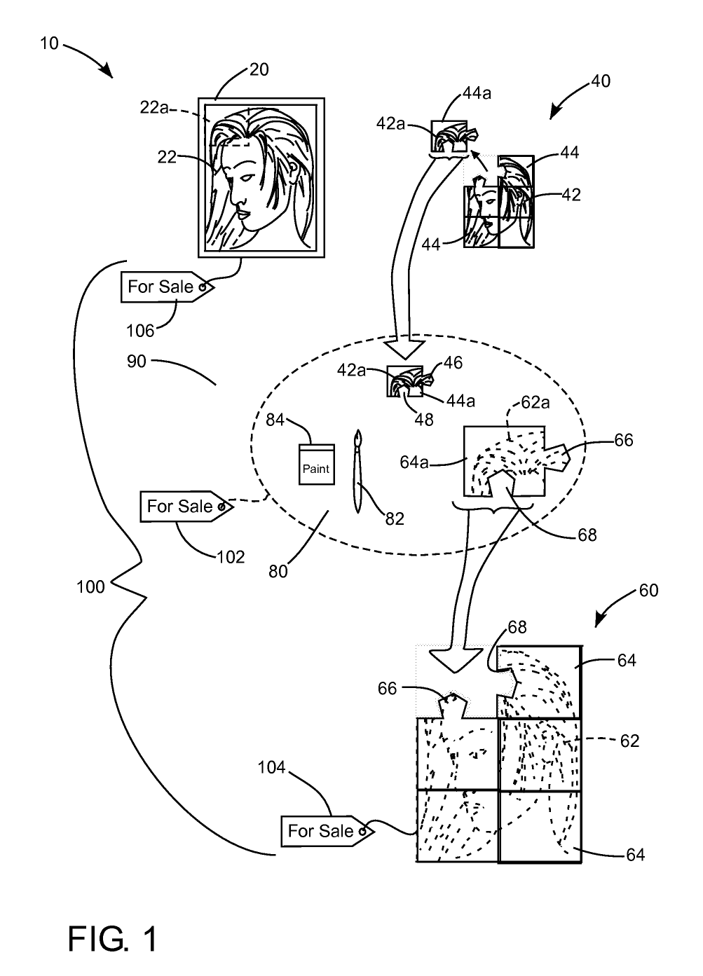

As illustrated in FIG. 1, an art project system, indicated generally at 10, is shown in accordance with an embodiment of the present invention for conducting a group-based activity. The art project system can include a master visual art work 20, a copy of the master visual art work, indicated generally at 40, a plurality of blank pieces, indicated generally at 60, and art tools and supplies, indicated generally at 80.

The master visual art work 20 can be any type of visual art. For example, as shown in FIG. 1, the master visual art work can be a two dimensional graphical work of art such as a painting 22, a photograph, a computer generated graphical image, and the like. The master visual art work can be formed on a medium suitable for reproduction, such as paper, canvas, velum, and the like.

The copy of the master visual art work 40 can be a digital replica of the master visual art work and can include a reproduction 42 of the master visual art work 22. The copy 40 can be produced by a printer, copier, scanner and the like. The copy 40 of the master visual art work can be divided into a plurality of divided pieces 44.

The plurality of blank pieces 60 can be formed from a medium suitable for reproducing the master visual work of art 20. Each blank piece 64 in the plurality of blank pieces 60 can correspond in shape to a different one of the plurality of divided pieces 44. The plurality of blank pieces 60 can be assembled together to form a complete reproduction of the assembled divided pieces 44. The blank pieces can also be proportionally smaller or larger than the divided pieces. In this way, the plurality of blank pieces can form a scaled replica of the master visual art work 20 when the blank pieces are transformed to reproduce the corresponding divided pieces and then assembled together.

As shown in the embodiment in FIG. 1, the plurality of divided pieces 40 and the plurality of blank pieces 60 can be sized and shaped as puzzle pieces having interlocking tabs 44 and 64, and slots 46 and 66. The tabs and slots can fit together to facilitate assembly of the pieces into a reproduction of the master visual art work 20.

The art tools and supplies 80 can include materials, tools, and equipment for altering or transforming each blank piece 64 into a reproduction of the corresponding divided piece 44. For example, as shown in FIG. 1, the tools and supplies can include paint brushes 82 and paint 84. The tools and supplies can be used to reproduce the image 42a on the divided piece 44a as a similar image 62a on the corresponding blank piece 64a.

Thus, by using the tools and supplies 80, the portion 22a of the image 22 shown as a reproduction 42a on the divided piece 44a can be reproduced as an image 62a on the corresponding blank piece 64a. In this way, a reproduction, indicated by dashed lines at 52, of the painting 22 can be formed by assembling all of the blank pieces 64 together.

Additionally, the plurality of divided pieces 40, the plurality of blank pieces 60, and the tools and supplies 80 can be separated into a plurality of kits, indicated generally at 90. Each of the kits can be distributable to members of a group participating in the group-based activity. Each kit can include one of the plurality of divided pieces 44a, the blank piece 64a that corresponds to the divided piece 44a, and at least a portion of the tools and supplies 80 needed for altering the blank piece to match the corresponding divided piece.

The art project system 10 can be used for a variety of group-based activities. For example, in the embodiment shown in FIG. 1, the group-based activity can be a fundraiser for generating revenue. In this case, the system 10 can also include a plurality of sales offers, indicated generally at 100, designed to generate revenue throughout the progression of the group activity based on the art project system. Thus, the system can include a first sales offer consisting of an offer to sell 102 each of the plurality of kits 90. Selling the kits can provide a first opportunity to generate revenue during the group-based art project.

A second sales offer can include an offer to sell 104 the reproduction of the master visual art work 60 created from an assembly of the plurality of formerly blank pieces 64 after each blank piece has been altered to reproduce the corresponding divided piece 44. The offer to sell 104 the reproduced master visual art work 60 can provide a second opportunity to generate revenue.

A third sales offer can include an offer to sell 106 the master visual art work 20. The offer to sell 106 the master visual art work 20 can provide a third opportunity to generate revenue.

Other opportunities for generating revenue can also be envisioned by the embodiments of the group-based activity centered on the art project system 10 described herein. For example, the group-based activity can “pre-sell” images that can be used in future fundraising events as a result of the excitement just experienced using the present art project system 10.

The sales opportunities of the various parts of the art project system 10 can include a variety of types of sales offers. For example, the offers to sell can include a sales offer document such as price tags 102, 104 and 106, a contract, a silent bid form, and the like. As another example the offers to sell can include live or silent auctioning of the assembled reproduction 60 and the master visual art work 30 to the highest bidders.

In this way, the embodiments of the art project system 10 described herein advantageously can provide multiple opportunities for generating revenue rather than a single sales point when the art project system is purchased as commonly found in the prior art. It will be appreciated that multiple revenue generating activities greatly increase the amount of revenue that can potentially be raised by a fundraising activity.

In summary, the embodiments of the invention described above and shown in FIG. 1 provide for a group based activity centered on a master visual art work 20 such as a painting 22, photograph, sculpture, and the like. The master visual work of art can have a configuration that facilitates reproduction by amateur artists in small sections 64. The small sections can be developed from a smaller copy 40 of the master work of art which is cut or divided into several smaller pieces 44. In one aspect, the smaller copy 40 can be divided into approximately 16 to 25 pieces. Additionally, the pieces can be shaped as puzzle pieces. Corresponding blank pieces 64 that are similar in shape to the smaller pieces 44, but proportionally smaller or larger, can then be produced such that every smaller piece 44 corresponds to a different larger piece 64. The larger blank piece 64 and the corresponding smaller piece 44 can then be placed in a kit 90 along with art supplies 80. The art supplies 80 can be used to transform the blank piece 64 into a replica of the smaller piece 44.

Advantageously, the art project system 10 shown in FIG. 1 can be used as a fundraiser or fundraising activity. For example, the kits 90 can be sold to a group needing to raise funds. The group can then, in turn, sell each kit to people who attend a fundraising event. The kits can be sold for a reasonable profit to provide a first fund raising opportunity. During the fundraising event, the purchasers of the kits can use the art supplies 80 to create a replica of the smaller piece 44 out of the larger blank piece 64. Knowledge of what the pieces are or how they fit together to form a larger recreation of the original master visual art work 20 can be kept from the purchasers to enhance the surprise effect when all of the replicated pieces are finally assembled at the end of the fund raising event. When the blank pieces 64 are complete, the purchasers can turn the now transformed blank pieces into fundraiser event staff so the pieces can be assembled. In one aspect, the assembly process can be conducted under a veil (not shown) so as to retain the surprise effect at the end of the event when the assembled pieces can be unveiled along with the original visual work of art. The now assembled replica created from the plurality of pieces and the original work of art can then be sold. In one embodiment the sale of the original master work of art 20 and the reproduction 60 can be completed by an auction. Sales of the original work of art and the reproduction can provide second and third opportunities for raising money in the fundraising event.

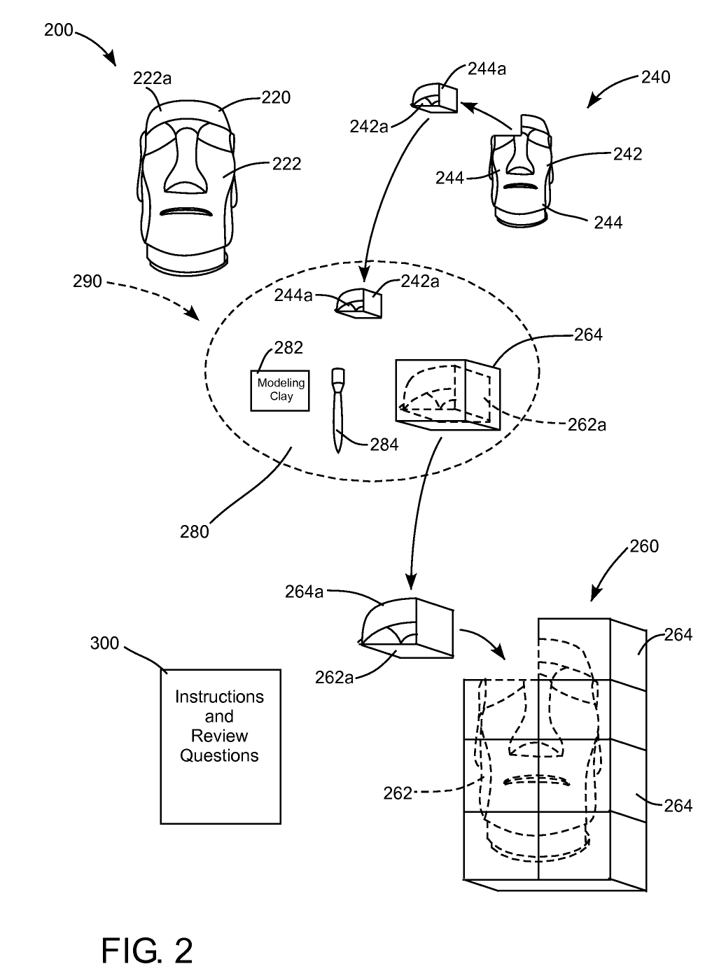

As Illustrated in FIG. 2, an art project system, indicated generally at 200, is shown in accordance with another embodiment of the present invention for conducting a group-based activity. The art project system 200 can be similar in many respects to the art project system 10 described above and shown in FIG. 1. The art project system 200 can include a master visual art work 220, a copy of the master visual art work, indicated generally at 240, a plurality of blank pieces, indicated generally at 260, and art tools and supplies, indicated generally at 280.

The master visual art work 220 can include a three dimensional work of art such as a sculpture 222, statue, model, extrusion, casting, molding, and the like. The master visual art work can be of suitable complexity so as to allow and even facilitate reproduction.

The copy of the master visual art work 240 can include a scaled replica 242 of the master visual art work 220. The scaled replica can be divided into a plurality of divided pieces 244.

The plurality of blank pieces 260 can be formed of a material suitable for reproducing a corresponding divided piece. Hence each blank piece 264a can correspond in shape to one of the divided pieces 244a. The blank pieces can also correspond by a larger or smaller scalar factor in size to the divided piece.

The art tools and supplies 280 can include materials, tools, and equipment for altering or transforming each blank piece 264 into a reproduction of the corresponding divided piece 244. For example, as shown in FIG. 2, the tools and supplies can include modeling clay 282 and sculpting knives 284. The tools and supplies can be used to reproduce the section 242a on the divided piece 244a as a similar section 262a on the corresponding blank piece 264a.

Thus, by using the tools and supplies 280, the portion 222a of the section 222 shown as a reproduction 242a on the divided piece 244a can be reproduced as a section 262a on the corresponding blank piece 264a. In this way, a reproduction, indicated by dashed lines at 262, of the sculpture 222 can be formed by assembling all of the now formed blank pieces 264 together.

As discussed above, each of the divided pieces 244 along with the corresponding blank piece 264, and suitable tools and supplies 280 for altering the blank piece can be grouped together to form a kit 290. Each kit can be distributed to participants in the group activity.

In use, once the participants in the group activity receive the kit 290, the participant can create a scaled reproduction or replica of the divided piece 244 in the kit with the blank piece 264. The participant can then assemble the reproduction of the divided piece with other reproduced divided pieces that were reproduced by other participants in the group activity to form a reproduction 260 of the original master work of art 220.

The embodiment shown in FIG. 2 can also be used as a fundraiser activity as described above and shown in FIG. 1. However, as shown in FIG. 2, the group-based activity can also be a team building activity where each participant in the activity is a member of the collective team working on the art project system 10 or 200. In the case shown in FIG. 2, the art project system 200 can also include a set of instructions and questions 300 for conducting a question and answer session with the participants of the activity. The instructions and questions 300 can be used by a group moderator to help the participants analogize the art project activity to normal team activities, and to facilitate self-improvement and introspective discovery among the participants.

It will be appreciate that all of the embodiments of the art project systems described herein and shown in FIGS. 1-3 can be used in either the group-based fundraising activity or the team building activity. Additionally, the embodiments of the art project system described herein can be used in other group-based activities, such as party games, educational activities, retail home party packages for children and adults, small and large public or community art projects, and the like.

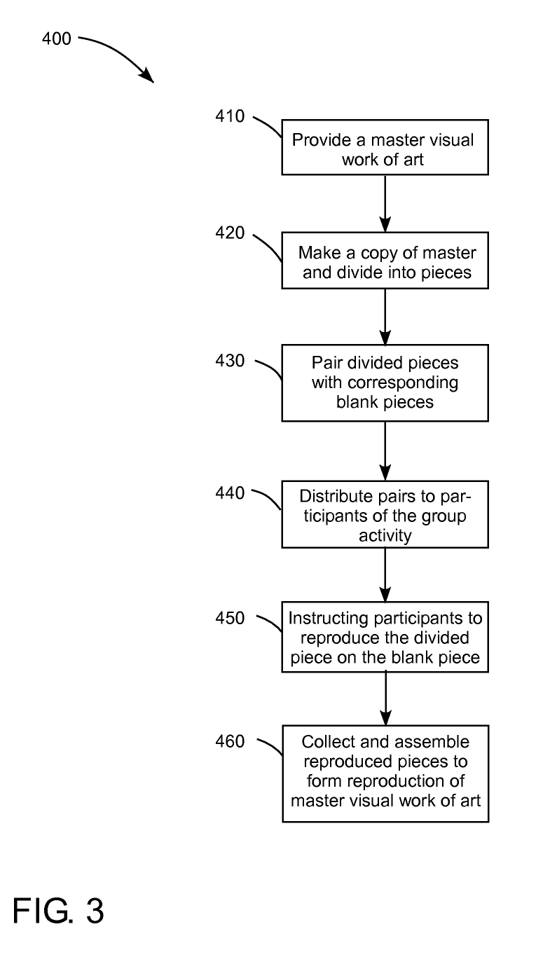

As shown in FIG. 3, the present invention also provides for a method for conducting a group-based activity, indicated generally at 400, including providing a master visual art work suitable for reproduction, as shown at 410. A copy of the master visual art work can be made and the copy can be divided into a plurality of divided pieces as shown at 420. Each of the pieces can be paired with a corresponding blank piece having substantially the same shape as the corresponding divided piece, as shown at 430. Each of the pairs can be distributed to at least one participant of the group-based activity, as shown at 440. The participants can be instructed to reproduce the divided piece on the blank piece using supplies distributed with each of the pairs, as shown at 450. The reproduced pieces can be collected and assembled to form a reproduction of the master visual art work, as shown at 460.

In one aspect, the master visual art work can be a painting. In this case, the blank piece can include a paintable surface, and the supplies for creating the reproduction can include a paint brush and paint. The supplies can be used to paint the portion of the master visual art work found on the divided piece paired with the blank piece onto the blank piece.

In another aspect, the master visual art work can be a sculpture. In this case, the blank piece can include a sculpting material, and the supplies for creating the reproduction can include sculpting tools. The supplies can be used to sculpt the portion of the master visual art work found on the divided piece paired with the blank piece onto the blank piece.

In yet another aspect, the group-based activity can be a fundraiser and the method can include offering for sale each of the pairs and the supplies as kit, thereby providing a first opportunity to generate revenue. A reproduction of the master visual art work created from an assembly of the plurality of blank pieces when each blank piece has been altered to reproduce the corresponding divided piece can also be offered for sale, thereby providing a second opportunity to generate revenue. The master visual art work can also be offered for sale, thereby providing a third opportunity to generate revenue.

In yet another aspect, the group-based activity can be a team building activity and the method can include conducting a question and answer session with participants of the activity to help the participants analogize the activity to teamwork skills, such as cross functional cooperation, multi-discipline consensus building, and the like. The question and answer session can also facilitate self-improvement, communication skills development, and introspective discovery among the participants.

The present invention can also provide for a method for fundraising including providing a master visual art work suitable for reproduction. A copy of the master visual art work can be made. The copy can be divided into a plurality of pieces. Each of the divided pieces can be paired with a corresponding blank piece. Each of the pairs can be distributed to a participant for reproduction of the divided piece onto the blank piece. The reproduced pieces can be collected and assembled to form an assembled reproduction of the master visual art work. The assembled reproduction can be offered for sale to produce revenue for the fundraiser.

The method can also include offering for sale each of the pairs of pieces and the supplies as a kit to provide an additional opportunity to generate revenue. The master visual art work can also be offered for sale to provide an additional opportunity to generate revenue.

The present invention also provides for a method for conducting a group-based team building activity including providing a master visual art work suitable for reproduction. A copy of the master visual art work can be made. The copy can be divided into a plurality of pieces. Each of the divided pieces can be paired with a corresponding blank piece. Each of the pairs can be distributed to a different participant. The participant can be instructed to reproduce the divided piece on the blank piece. The reproduced pieces can be collected and assembled to form an assembled reproduction of the master visual art work. A question and answer session can be conducted with participants of the activity to help the participants analogize the activity to teamwork skills and to facilitate self-improvement and introspective discovery among the participants.

The method can also include a fundraising activity including offering the assembled reproduction for sale to produce revenue for the fundraiser. Each of the pairs and the supplies can also be offered for sale so as to provide an additional opportunity to generate revenue. Similarly, the master visual art work can be offered for sale to provide an additional opportunity to generate revenue.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An art project system, comprising:
a) a master visual art work suitable for reproduction;
b) a copy of the master visual art work separated into a plurality of divided pieces;
c) a plurality of blank pieces, each blank piece corresponding to a different one of the plurality of divided pieces; and
d) supplies for transforming each blank piece to reproduce the corresponding divided piece.

2. A system in accordance with claim 1, further comprising a plurality of kits, each kit being distributable to members of a group participating in a group-based activity using the art project system, each kit further comprising:
a) one of the plurality of divided pieces;
b) the blank piece that corresponds to the one of the plurality of divided pieces; and
c) a portion of the supplies for transforming the blank piece to match the corresponding divided piece.

3. A system in accordance with claim 2, wherein the group-based activity is a fundraiser and the system further includes:
a) a first sales opportunity constituting an offer for sale for each of the plurality of kits and providing a first opportunity to generate revenue;
b) a second sales opportunity constituting an offer for sale for a reproduction of the master visual art work created from an assembly of the plurality of blank pieces when each blank piece has been altered to reproduce the corresponding divided piece, the second sales opportunity providing a second opportunity to generate revenue; and
c) a third sales opportunity constituting an offer for sale for the master visual art work providing a third opportunity to generate revenue.

4. A system in accordance with claim 3, wherein the first, second and third sales opportunities include at least one document constituting the offer for sale.

5. A system in accordance with claim 3, wherein at least one of the first, second and third sales opportunities further include auctioning the assembled reproduction to a highest bidder.

6. A system in accordance with claim 2, wherein the group-based activity is a team building activity and the system further includes:
a set of instructions and questions for conducting a question and answer session with participants of the activity to help the participants analogize the activity normal team activities and to facilitate self-improvement and introspective discovery among the participants.

7. A system in accordance with claim 1, wherein the master visual art work includes a graphical art work selected from a painting, a photograph, a computer generated graphical image, a two-dimensional graphical image, and combinations thereof; and
the supplies for transforming each blank piece include a material for creating a reproduction of the divided piece from the corresponding blank piece.

8. A system in accordance with claim 7, wherein the material for creating the reproduction includes paint.

9. A system in accordance with claim 1, wherein the master visual art work is a three dimensional work of art, and the supplies for altering each blank piece include a material for creating a three dimensional reproduction of the divided piece.

10. A system in accordance with claim 1, wherein the plurality of divided pieces and the plurality of blank pieces are sized and shaped as puzzle pieces having interlocking tabs and slots for assembly of the pieces into a reproduction of the master visual art work.

11. A method for conducting a group-based activity, comprising:
a) providing a master visual art work suitable for reproduction;
b) making a copy of the master visual art work;
c) dividing the copy into a plurality of divided pieces;
d) pairing each of the pieces with a corresponding blank piece having substantially the same shape as the corresponding divided piece;
e) distributing each of the pairs to at least one participant of the group-based activity;
f) instructing the at least one participant to reproduce the divided piece on the blank piece using supplies distributed with each of the pairs;
g) collecting the reproduced pieces; and
h) assembling the reproduced pieces to form an assembled reproduction of the master visual art work.

12. A method in accordance with claim 11, wherein the master visual art work includes a graphical art work selected from a painting, a photograph, a computer generated graphical image, a two-dimensional graphical image, and combinations thereof; and the supplies include a medium for creating a reproduction of the divided piece from the corresponding blank piece.

13. A method in accordance with claim 12, wherein the blank piece includes a paintable surface, and the medium for creating the reproduction includes a paint brush and paint.

14. A method in accordance with claim 11, wherein the master visual art work is three dimensional and the supplies and the blank piece include a medium for creating a three dimensional reproduction of the divided piece.

15. A method in accordance with claim 11, wherein the group-based activity is a fundraiser and the method further includes:
a) offering for sale each of the pairs and the supplies, thereby providing a first opportunity to generate revenue;
b) offering for sale a reproduction of the master visual art work created from an assembly of the plurality of blank pieces when each blank piece has been altered to reproduce the corresponding divided piece, thereby providing a second opportunity to generate revenue; and
c) offering for sale the master visual art work, thereby providing a third opportunity to generate revenue.

16. A method in accordance with claim 11, wherein the group-based activity is a team building activity and the method further includes:
conducting a question and answer session with participants of the activity to help the participants analogize the activity to teamwork skills and to facilitate self-improvement and introspective discovery among the participants.

17. A method for fundraising, comprising:
a) providing a master visual art work suitable for reproduction;
b) making a copy of the master visual art work;
c) dividing the copy into a plurality of pieces;
d) pairing each of the pieces with a corresponding blank piece;
e) distributing each of the pairs to a participant for reproduction of the divided piece onto the blank piece;
f) collecting the reproduced pieces;
g) assembling the reproduced pieces to form an assembled reproduction of the master visual art work; and
h) offering the assembled reproduction for sale to produce revenue for the fundraiser.

18. A method in accordance with claim 17, wherein the fundraiser further includes:
a) offering for sale each of the pairs and the supplies, thereby providing an additional opportunity to generate revenue; and
c) offering for sale the master visual art work, thereby providing an additional opportunity to generate revenue.

19. A method for conducting a group-based team building activity, comprising:
a) providing a master visual art work suitable for reproduction;
b) making a copy of the master visual art work;
c) dividing the copy into a plurality of pieces;
d) pairing each of the pieces with a corresponding blank piece;
e) distributing each of the pairs to at least one participant;
f) instructing the at least one participant to reproduce the divided piece on the blank piece;
g) collecting the reproduced pieces;
h) assembling the reproduced pieces to form an assembled reproduction of the master visual art work; and
i) conducting a question and answer session with participants of the activity to help the participants analogize the activity to teamwork skills and to facilitate self-improvement and introspective discovery among the participants.

20. A method in accordance with claim 19, wherein the method includes a fundraising activity, comprising:
a) offering the assembled reproduction for sale to produce revenue for the fundraiser;
b) offering for sale each of the pairs and the supplies, thereby providing an additional opportunity to generate revenue; and
c) offering for sale the master visual art work, thereby providing an additional opportunity to generate revenue.
